(19) United States
(12) Patent Application Publication
(10) Pub. No.: US 2015/0322614 A1
(43) Pub. Date: Nov. 12, 2015

(54) LAUNDRY TREATING APPLIANCE WITH DYNAMIC BALANCER

(71) Applicant: WHIRLPOOL CORPORATION, Benton Harbor, MI (US)

(72) Inventors: CHRISTOPHER L. BORLIN, STEVENSVILLE, MI (US); MARK R. HASLANGER, SOUTH BEND, IN (US); GEORGE W. MALHEIROS, SAINT JOSEPH, MI (US); STEPHEN D. OSTDIEK, SAINT JOSEPH, MI (US)

(73) Assignee: WHIRLPOOL CORPORATION, Benton Harbor, MI (US)

(21) Appl. No.: 14/696,721

(22) Filed: Apr. 27, 2015

Related U.S. Application Data
(60) Provisional application No. 61/990,972, filed on May 9, 2014.

(51) Int. Cl. D06F 37/24; F16F 7/10; D06F 39/00

(52) U.S. Cl. CPC D06F 37/245; D06F 39/003; F16F 7/10; F16F 7/1034; F16F 2226/04

(57) ABSTRACT

A dynamic balancer device for mounting to and balancing a rotatable drum in a laundry treating appliance comprises an enclosed non-metal annular housing having a radial circumferential wall, an annular metal race within the non-metal annular housing disposed against the radial circumferential wall, and a mass disposed in the annular race and movable therein.

### CROSS-REFERENCE TO RELATED APPLICATIONS

This application claims the benefit of U.S. Provisional Patent Application No. 61/990,972, filed May 9, 2014, which is incorporated herein by reference in its entirety.

### BACKGROUND OF THE INVENTION

Laundry treating appliances, such as a washing machine, may implement cycles of operation in which a drum defining a treating chamber for receiving a laundry load is rotated at high speeds, such as a spin or water extraction phase. For example, to extract the water from the laundry load, the drum is typically spun at high speeds. If a sufficiently large enough load imbalance is present, the laundry treating appliance may experience undesirable vibrations and movements when the drum is rotated at high speeds during the spin phase.

### SUMMARY OF THE INVENTION

In one aspect, a dynamic balancer device for mounting to and balancing a rotatable drum in a laundry treating appliance comprises an enclosed non-metal annular housing having a radial circumferential wall, an annular metal race within the non-metal annular housing disposed against the radial circumferential wall, and a mass disposed in the annular race and movable therein.

### BRIEF DESCRIPTION OF THE DRAWINGS IN THE DRAWINGS

FIG. 1 is a schematic view of a laundry treating appliance in the form of a washing machine according to an embodiment of the invention.

FIG. 2 is a schematic of a control system of the laundry treating appliance of FIG. 1 according to an embodiment of the invention.

FIG. 3 is an isometric view, partly in cross section, of a dynamic balancer in accordance with an embodiment of the invention.

FIG. 4 is a cross section of the dynamic balancer of FIG. 3 taken along lines IV-Iv.

FIG. 5 is a cross section of a dynamic balancer in accordance with another embodiment of the invention.

FIG. 6 is a cross section of a dynamic balancer in accordance with another embodiment of the invention.

FIG. 7 is a cross section of a dynamic balancer in accordance with another embodiment of the invention.

FIG. 8 is a cross section of a dynamic balancer in accordance with another embodiment of the invention.

FIG. 9 is a cross section of a dynamic balancer in accordance with another embodiment of the invention.

FIG. 10A is a cross section of a dynamic balancer in accordance with another embodiment of the invention.

FIG. 10B is a cross section of a dynamic balancer in accordance with another embodiment of the invention.

FIG. 11 is a schematic view of a laundry treating appliance in the form of a washing machine according to another embodiment of the invention.

### DESCRIPTION OF EMBODIMENTS OF THE INVENTION

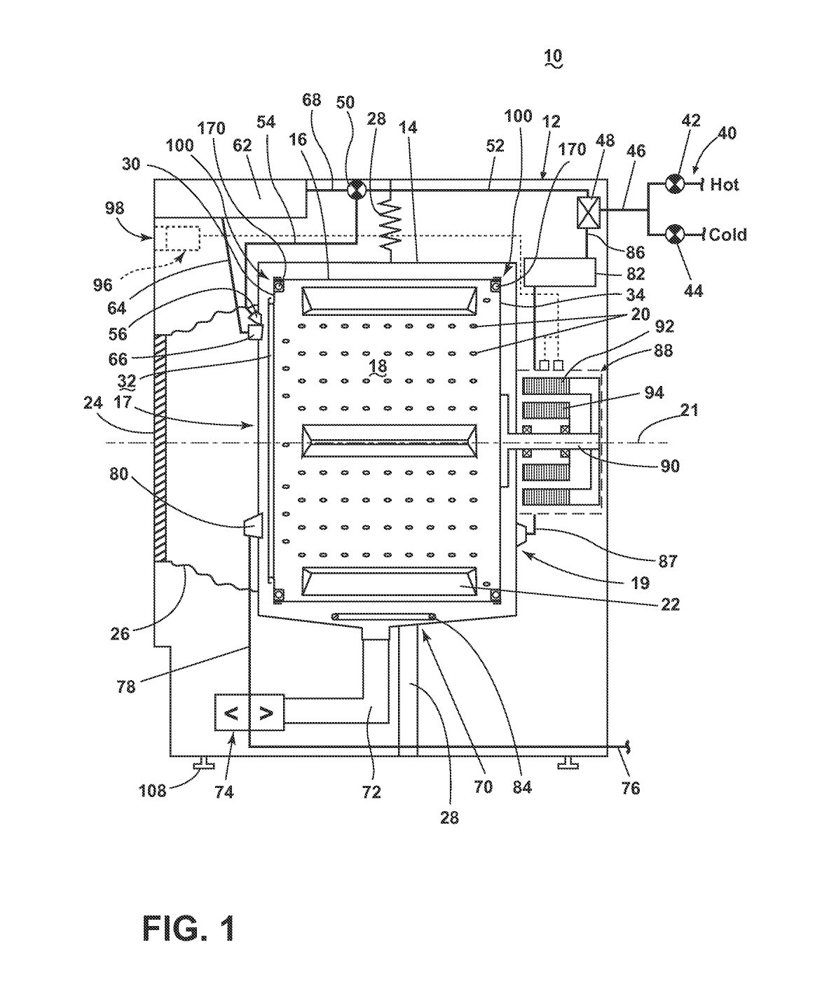

FIG. 1 is a schematic view of a laundry treating appliance according to a first embodiment of the invention. The laundry treating appliance may be any appliance which performs a cycle of operation to clean or otherwise treat items placed therein, non-limiting examples of which include a horizontal or vertical axis clothes washer; a combination washing machine and dryer; a tumbling or stationary refreshing/revitalizing machine; an extractor; a non-aqueous washing apparatus; and a revitalizing machine.

The laundry treating appliance of FIG. 1 is illustrated as a washing machine 10, which may include a structural support system comprising a cabinet 12 which defines a housing within which a laundry holding system resides. The cabinet 12 may be a housing having a chassis and/or a frame, defining an interior that encloses components typically found in a conventional washing machine, such as motors, pumps, fluid lines, controls, sensors, transducers, and the like. Such components will not be described further herein except as necessary for a complete understanding of the invention.

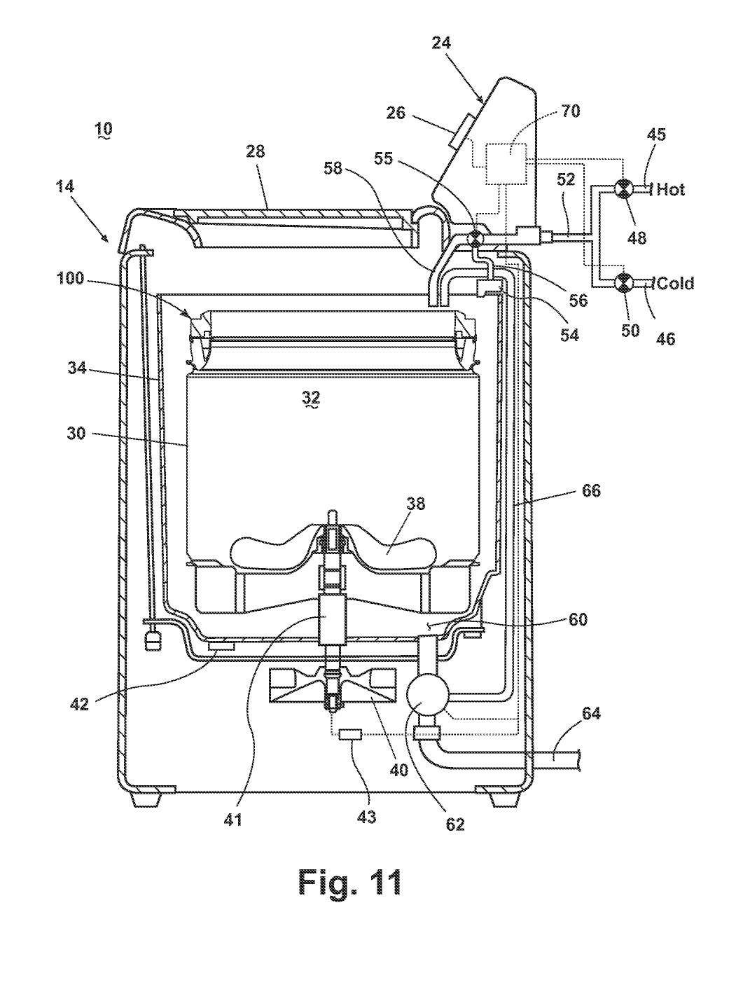

The laundry holding system comprises a tub 14 supported within the cabinet 12 by a suitable suspension system and a rotatable drum 16 provided within the tub 14, the rotatable drum 16 defining at least a portion of a laundry treating chamber 18 having a longitudinal axis 21. The longitudinal axis 21 of the rotatable drum 16 is preferably coincident with a horizontal or non-vertical axis of rotation of the drum 16, though it is within the scope of the invention to accommodate a rotatable drum on a vertical axis of rotation. See, for example, an embodiment of a vertical axis washing machine according to the invention in FIG. 11. The rotatable drum 16 may include a plurality of perforations 20 such that liquid may flow between the tub 14 and the rotatable drum 16 through the perforations 20. A plurality of baffles 22 may be disposed on an inner surface of the rotatable drum 16 to lift the laundry load received in the treating chamber 18 while the rotatable drum 16 rotates. It is also within the scope of the invention for the laundry holding system to comprise only a tub with the tub defining the laundry treating chamber.

The rotatable drum 16 has a front side 17 and a rear side 19. The front side 17 includes a front cover 30 with an opening 32 therein to accommodate receiving laundry. The rear side 19 also has a rear cover 34. The covers 30, 34 thus form part of the drum 16.

The laundry holding system may further include a door 24 which may be movably mounted to the cabinet 12 to selectively close both the tub 14 and the drum 16. A bellows 26 may couple an open face of the tub 14 with the cabinet 12, with the door 24 sealing against the bellows 26 when the door 24 closes the tub 14.

The washing machine 10 may further include a suspension system 28 for dynamically suspending the laundry holding system within the structural support system.

The washing machine 10 may further include a liquid supply system for supplying water to the washing machine 10 for use in treating laundry during a cycle of operation. The liquid supply system may include a source of water, such as a household water supply 40, which may include separate valves 42 and 44 for controlling the flow of hot and cold water, respectively. Water may be supplied through an inlet conduit 46 directly to the tub 14 by controlling first and second diverter mechanisms 48 and 50, respectively. The diverter mechanisms 48, 50 may be a diverter valve having two outlets such that the diverter mechanisms 48, 50 may selectively direct a flow of liquid to one or both of two flow paths. Water from the household water supply 40 may flow through the inlet conduit 46 to the first diverter mechanism 48 which may direct the flow of liquid to a supply conduit 52. The second diverter mechanism 50 on the supply conduit 52 may direct the flow of liquid to a tub outlet conduit 54 which may be provided with a spray nozzle 56 configured to spray the flow of liquid into the tub 14. In this manner, water from the household water supply 40 may be supplied directly to the tub 14.

The washing machine 10 may also be provided with a dispensing system for dispensing treating chemistry to the treating chamber 18 for use in treating the laundry according to a cycle of operation. The dispensing system may include a dispenser 62 which may be a single use dispenser, a bulk dispenser or a combination of a single use and a bulk dispenser. Non-limiting examples of suitable dispensers are disclosed in U.S. Pat. No. 8,196,441 to Hendrickson et al., filed Jul. 1, 2008, entitled “Household Cleaning Appliance with a Dispensing System Operable Between a Single Use Dispensing System and a Bulk Dispensing System,” U.S. Pat. No. 8,388,695 to Hendrickson et al., filed Jul. 1, 2008, entitled “Apparatus and Method for Controlling Laundering Cycle by Sensing Wash Aid Concentration,” U.S. Pat. No. 8,397,328 to Hendrickson et al., filed Jul. 1, 2008, entitled “Apparatus and Method for Controlling Concentration of Wash Aid in Wash Liquid,” U.S. Pub. No. 2010/0000581 to Doyle et al., filed Jul. 1, 2008, entitled “Water Flow Paths in a Household Cleaning Appliance with Single Use and Bulk Dispensing,” U.S. Pub. No. 2010/0000264 to Luckman et al., filed Jul. 1, 2008, now U.S. Pat. No. 8,813,526, issued Aug. 26, 2014, entitled “Method for Converting a Household Cleaning Appliance with a Non-Bulk Dispensing System to a Household Cleaning Appliance with a Bulk Dispensing System,” U.S. Pat. No. 8,397,544 to Hendrickson, filed Jun. 23, 2009, entitled “Household Cleaning Appliance with a Single Water Flow Path for Both Non-Bulk and Bulk Dispensing,” and U.S. Pat. No. 8,438,881 to Ihne et al., filed Apr. 25, 2011, entitled “Method and Apparatus for Dispensing Treating Chemistry in a Laundry Treating Appliance,” which are herein incorporated by reference in full.

Regardless of the type of dispenser used, the dispenser 62 may be configured to dispense a treating chemistry directly to the tub 14 or mixed with water from the liquid supply system through a dispensing outlet conduit 64. The dispensing outlet conduit 64 may include a dispensing nozzle 66 configured to dispense the treating chemistry into the tub 14 in a desired pattern and under a desired amount of pressure. For example, the dispensing nozzle 66 may be configured to dispense a flow or stream of treating chemistry into the tub 14 by gravity, i.e. a non-pressurized stream. Water may be supplied to the dispenser 62 from the supply conduit 52 by directing the diverter mechanism 50 to direct the flow of water to a dispensing supply conduit 68.

Non-limiting examples of treating chemistries that may be dispensed by the dispensing system during a cycle of operation include one or more of the following: water, enzymes, fragrances, stiffness/sizing agents, wrinkle releasers/reducers, softeners, antistatic or electrostatic agents, stain repellants, water repellants, energy reduction/extraction aids, antibacterial agents, medicinal agents, vitamins, moisturizers, shrinkage inhibitors, and color fidelity agents, and combinations thereof.

The washing machine 10 may also include a recirculation and drain system for recirculating liquid within the laundry holding system and draining liquid from the washing machine 10. Liquid supplied to the tub 14 through the tub outlet conduit 54 and/or the dispensing supply conduit 68 typically enters a space between the tub 14 and the drum 16 and may flow by gravity to a sump 70 formed in part by a lower portion of the tub 14. The sump 70 may also be formed by a sump conduit 72 that may fluidly couple the lower portion of the tub 14 to a pump 74. The pump 74 may direct liquid to a drain conduit 76, which may drain the liquid from the washing machine 10, or to a recirculation conduit 78, which may terminate at a recirculation inlet 80. The recirculation inlet 80 may direct the liquid from the recirculation conduit 78 into the drum 16. The recirculation inlet 80 may introduce the liquid into the drum 16 in any suitable manner, such as by spraying, dripping, or providing a steady flow of liquid. In this manner, liquid provided to the tub 14, with or without treating chemistry may be recirculated into the treating chamber 18 for treating the laundry within.

The liquid supply and/or recirculation and drain system may be provided with a heating system which may include one or more devices for heating laundry and/or liquid supplied to the tub 14, such as a steam generator 82 and/or a sump heater 84. Liquid from the household water supply 40 may be provided to the steam generator 82 through the inlet conduit 46 by controlling the first diverter mechanism 48 to direct the flow of liquid to a steam supply conduit 86. Steam generated by the steam generator 82 may be supplied to the tub 14 through a steam outlet conduit 87. The steam generator 82 may be any suitable type of steam generator such as a flow through steam generator or a tank-type steam generator. Alternatively, the sump heater 84 may be used to generate steam in place of or in addition to the steam generator 82. In addition or alternatively to generating steam, the steam generator 82 and/or sump heater 84 may be used to heat the laundry and/or liquid within the tub 14 as part of a cycle of operation.

Additionally, the liquid supply and recirculation and drain system may differ from the configuration shown in FIG. 1, such as by inclusion of other valves, conduits, treating chemistry dispensers, sensors, such as water level sensors and temperature sensors, and the like, to control the flow of liquid through the washing machine 10 and for the introduction of more than one type of treating chemistry.

The washing machine 10 also includes a drive system for rotating the drum 16 within the tub 14. The drive system may include a motor 88, which may be directly coupled with the rotatable drum 16 through a drive shaft 90 at or about the rear cover 34 to rotate the drum 16 about a rotational axis during a cycle of operation. The motor 88 may be a brushless permanent magnet (BPM) motor having a stator 92 and a rotor 94. Alternately, the motor 88 may be coupled to the drum 16 through a belt and a drive shaft to rotate the rotatable drum 16, as is known in the art. Other motors, such as an induction motor or a permanent split capacitor (PSC) motor, may also be used. The motor 88 may rotate the drum 16 at various speeds in either rotational direction.

The washing machine 10 also includes a control system for controlling the operation of the washing machine 10 to implement one or more cycles of operation. The control system may include a controller 96 located within the cabinet 12 and a user interface 98 that is operably coupled with the controller 96. The user interface 98 may include one or more knobs, dials, switches, displays, touch screens and the like for communicating with the user, such as to receive input and provide output. The user may enter different types of information including, without limitation, cycle selection and cycle parameters, such as cycle options.

The controller 96 may include the machine controller and any additional controllers provided for controlling any of the components of the washing machine 10. For example, the controller 96 may include the machine controller and a motor controller. Many known types of controllers may be used for the controller 96. The specific type of controller is not germane to the invention. It is contemplated that the controller is a microprocessor-based controller that implements control software and sends/receives one or more electrical signals to/from each of the various working components to effect the control software. As an example, proportional control (P), proportional integral control (PI), and proportional derivative control (PD), or a combination thereof, a proportional integral derivative control (PID control), may be used to control the various components.

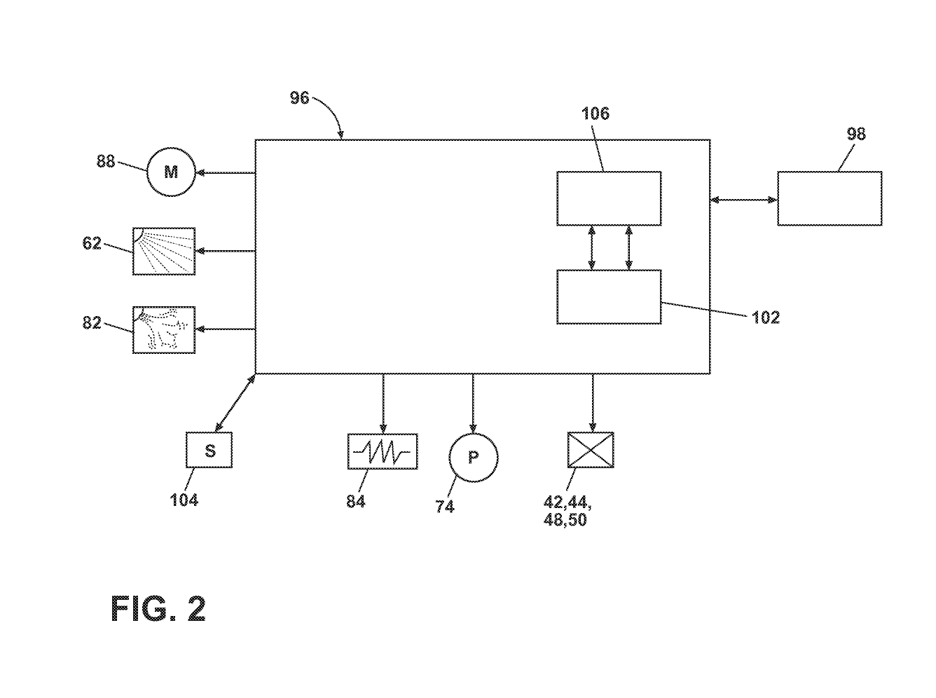

As illustrated in FIG. 2, the controller 96 may be provided with a memory 106 and a central processing unit (CPU) 102. The memory 106 may be used for storing the control software that is executed by the CPU 102 in completing a cycle of operation using the washing machine 10 and any additional software. Examples, without limitation, of cycles of operation include: wash, heavy duty wash, delicate wash, quick wash, pre-wash, refresh, rinse only, and timed wash. The memory 106 may also be used to store information, such as a database or table, and to store data received from one or more components of the washing machine 10 that may be communicably coupled with the controller 96. The database or table may be used to store the various operating parameters for the one or more cycles of operation, including factory default values for the operating parameters and any adjustments to them by the control system or by user input.

The controller 96 may be operably coupled with one or more components of the washing machine 10 for communicating with and controlling the operation of the component to complete a cycle of operation. For example, the controller 96 may be operably coupled with the motor 88, the pump 74, the dispenser 62, the steam generator 82 and the sump heater 84 to control the operation of these and other components to implement one or more of the cycles of operation.

The controller 96 may also be coupled with one or more sensors 104 provided in one or more of the systems of the washing machine 10 to receive input from the sensors, which are known in the art and not shown for simplicity. Non-limiting examples of sensors 104 that may be communicably coupled with the controller 96 include: a treating chamber temperature sensor, a moisture sensor, a weight sensor, a chemical sensor, a position sensor and a motor torque sensor, which may be used to determine a variety of system and laundry characteristics, such as laundry load inertia or mass.

The laundry treating appliance 10 may also include a dynamic balancer 100 at the front 17 and/or rear 19 side of the rotatable drum 16 which includes a moveable mass 170 to offset an imbalance that may occur in the treating chamber 18 during rotation of the rotatable drum 16 during a cycle of operation. In FIG. 1 a dynamic balancer 100 is shown at both the front 17 and rear 19 sides of the rotatable drum 16, secured to the front and rear covers 30, 34, respectively.

During a cycle of operation in which the drum 16 is rotated, the moveable mass 170 may apply pressure to parts of the balancer 100 as a result of the centrifugal force applied to the moveable mass 170, especially when the moveable mass 170 includes spherical weights, such as steel balls. Metal is generally stiffer than plastic and thus may be less likely to be deformed or damaged as a result of the centrifugal force applied to the moveable mass 170. However, contact between the moveable mass 170 and metal components of the balancer 100 during rotation of the drum 16 may generate undesirable sound. The balancer 100 may be provided with a sound damping component or combination of sound damping components to reduce undesirable sound generated by the balancer 100. As used herein, sound damping refers to reducing undesirable sound by absorption and/or redirection of sound waves. The balancers described herein combine the strength properties of metal with the sound damping properties of plastic to provide a balancer which is less likely to be deformed or damaged in use while attenuating undesirable sounds that may be generated by movement of the mass within the balancer.

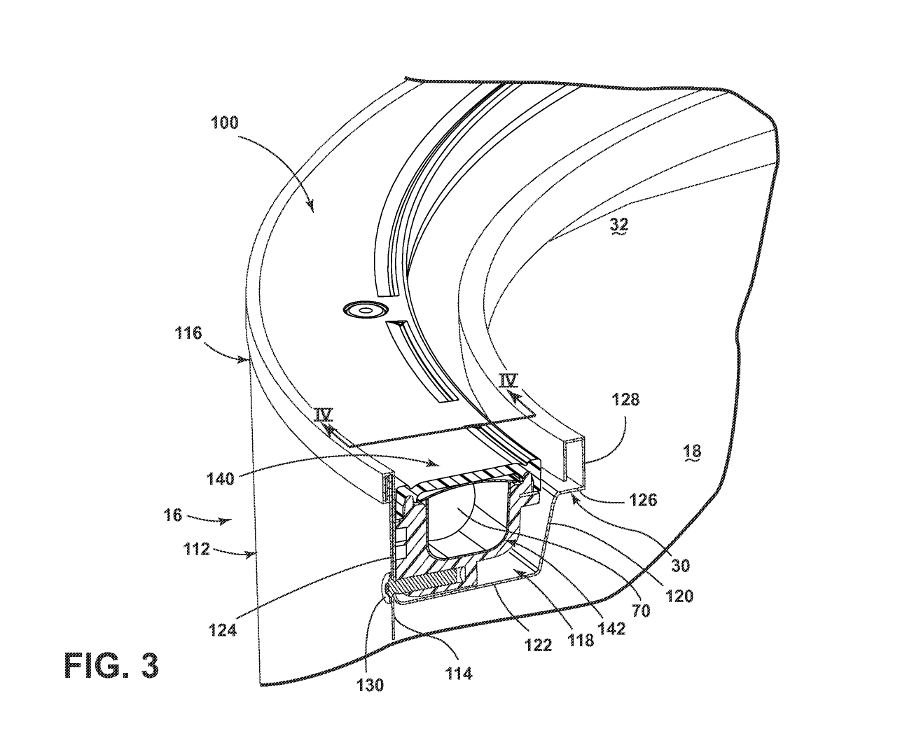

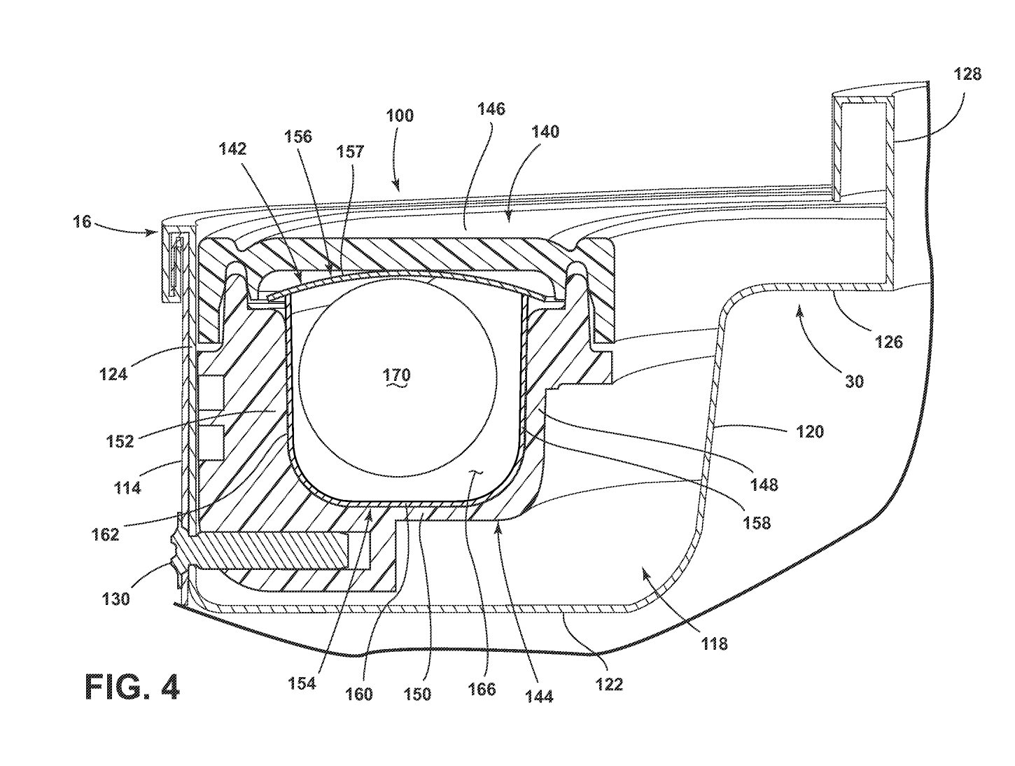

FIGS. 3-4 illustrate views of an embodiment of the dynamic balancer 100 in the context of a front cover 30 and its opening 32. Looking again also at FIG. 1, the dynamic balancer 100 is disposed coaxially with the longitudinal axis 21 of the treating chamber 18. The rotatable drum 16 encloses the treating chamber 18 in a cylindrical body 112 defined in part by a cylindrical wall 114 and the front cover 30. The front cover 30 is coupled to the cylindrical wall 114 at a suitable junction 116, which may include any of or any combination of crimping, welding, riveting, fastening, screwing, or the like. The front cover 30 of the drum 16 has an annular groove 118 defined by a first annular groove wall 120 and a second annular groove wall 122 extending from the first annular groove wall 120 to a third annular groove wall 124, the third annular groove wall 124 spaced from the first annular groove wall 120 and generally parallel thereto. A fourth annular groove wall 126 extends from the first wall 120 to an edge 128 that defines the opening 32. At least a portion of the fourth annular groove wall 126 extends generally normal to the longitudinal axis 21. In other words, it will be understood that the fourth annular groove wall 126 need not be planar and portions thereof may vary in orientation relative to the longitudinal axis 21. The front cover 30 is preferably made of metal, such as stainless steel, as is preferably the cylindrical wall 114.

The balancer 100 may be coupled with the front cover 30 within the annular groove 118 by mechanical fasteners, such as screws 130, or any other alternative or additional mechanical or non-mechanical fasteners, non-limiting examples of which include spring-clips, adhesives, welds, snap-fit connections, and tongue and groove connections.

The balancer 100 includes an enclosed non-metal annular housing 140 and an annular metal race 142 disposed within the annular housing 140. The annular housing 140 includes a first housing piece 144 and a second or cover housing piece 146. The annular non-metal housing 140 may be made from any suitable non-metal material, such as a polymeric material, which may be formed by a suitable molding process. The first housing piece 144 has a generally U-shaped cross-section defined by a first housing wall 148, a second housing wall 150, and a third housing wall 152. The annular housing 140 is secured within the annular groove 118 adjacent the third annular groove wall 124 and the cylindrical wall 114 such that the third housing wall 152 defines at least a portion of a radial circumferential housing wall with respect to the longitudinal axis 21 of the drum 16. As used herein, radial circumferential refers to a part or portion of a part which defines a radial circumferential limit of motion of the mass 170 during rotation of the drum 16 about the longitudinal axis 21. The radial circumferential wall may be formed by just the third housing wall 152 or a combination of the third housing wall 152 and adjacent portions of the housing 140.

The second housing piece 146 may be joined with the first and third housing walls 148, 152 of the first housing piece 144 by any suitable mechanical and/or non-mechanical fasteners, non-limiting examples of which include a tongue and groove connection (shown), a weld, a snap-fit connection, an adhesive, screws, rivets, and bosses. The second housing piece 146 may be joined with the first housing piece 144 to provide an enclosed annular space defined by the first, second, and third walls of the first housing piece 144, with the second housing piece 146 defining a fourth wall of the enclosed annular space.

The metal race 142 includes a first race piece 154 and a second, cover race piece 156. The metal race 142 may be made from any metal-based material, non-limiting examples of which include steel and aluminum. The first race piece 154 has a U-shaped cross-section corresponding to the U-shaped cross-section of the first housing piece 144, defined by a first race wall 158, a second race wall 160 and a third race wall 162. The third race wall 162 is disposed against the third housing wall 152 such that the third race wall 162 defines a radial circumferential race wall with respect to the longitudinal axis 21 of the drum 16. The second race piece 156 includes a fourth race wall 157 which may be joined with the first and third race walls 158, 162 of the first race piece 154 by any suitable mechanical and/or non-mechanical fasteners, non-limiting examples of which include a tongue and groove connection, a weld, a snap-fit connection, an adhesive, screws, rivets, and bosses. Alternatively, the second race piece 156 may be held in place by the second housing piece 146 when the second housing piece 146 is joined with the first housing piece 144.

The first, second, and third race walls 158, 160, and 162 define an annular raceway 166 within which the mass 170 may move. The fourth race wall 157 is provided to at least partially close the raceway 166 to form an enclosed raceway 166. The raceway 166 may include a fluid, such as water, salt water, oil or other viscous fluid, for example, and optionally one or more moveable weights, such as spherical balls. The mass 170 may partially fill the raceway 166 and may distribute or collect unevenly to offset an unbalanced condition in the rotatable drum 16.

The metal race 142 may be disposed within the annular housing 140 such that at least the third race wall 162 abuts the third housing wall 152 of the annular housing 140. As illustrated in FIG. 4, the metal race 142 is disposed within the annular housing 140 such that the first, second, and third race walls 158, 160, and 162 abut the first, second, and third housing walls 148, 150, and 152 and the fourth race wall 157 abuts the cover housing piece 146.

The annular housing 140 and the metal race 142 may be assembled either before or after the annular housing 140 is coupled with the drum cover 30. In one example, the first race piece 154 may be inserted into the annular housing 140 such that the first, second, and third race walls 158, 160, and 162 abut the first, second, and third housing walls 148, 150, and 152 and the fourth race wall 157 may be provided on the first and third race walls 158, 162 prior to joining the cover housing piece 146 with the first housing piece 144. Alternatively, the fourth race wall 157 may be provided on the first and third race walls 158, 162 at the same time as the cover housing piece 146 is joined with the first housing piece 144. In yet another example, the fourth race wall 157 may be provided on the first and third race walls 158, 162 of the first race piece 154 prior to inserting the thus assembled metal race 142 into the annular housing 140.

The mass 170 may be provided within the metal race 142 prior to providing the cover race piece 156 on the first and third race walls 158, 162. Alternatively, or additionally, the cover race piece 156 and, optionally, the cover housing piece 146, may be provided with one or more ports to provide access to the annular raceway 166. A fluid, such as oil, may be added to the annular raceway 166 through the port in the cover race piece 156 after the cover race piece 156 is provided on the first and third race walls 158, 162. In another example, both the cover race piece 156 and the cover housing piece 146 include aligned ports and the fluid may be added to the annular raceway 166 after cover housing piece 146 is provided on the first housing piece 144. In yet another example, the moveable mass 170 may include a combination of balls and a fluid. The balls may be provided in the annular raceway 166 prior to providing the cover race piece 156 and the fluid may be added through appropriate ports in the cover race piece 156 and optionally the cover housing piece 146. Alternatively, the moveable mass 170, either balls, fluid, or a combination of balls and fluid, may be added to the annular raceway 166 through appropriate sized port(s) provided in the cover race piece 156 and optionally the cover housing piece 146.

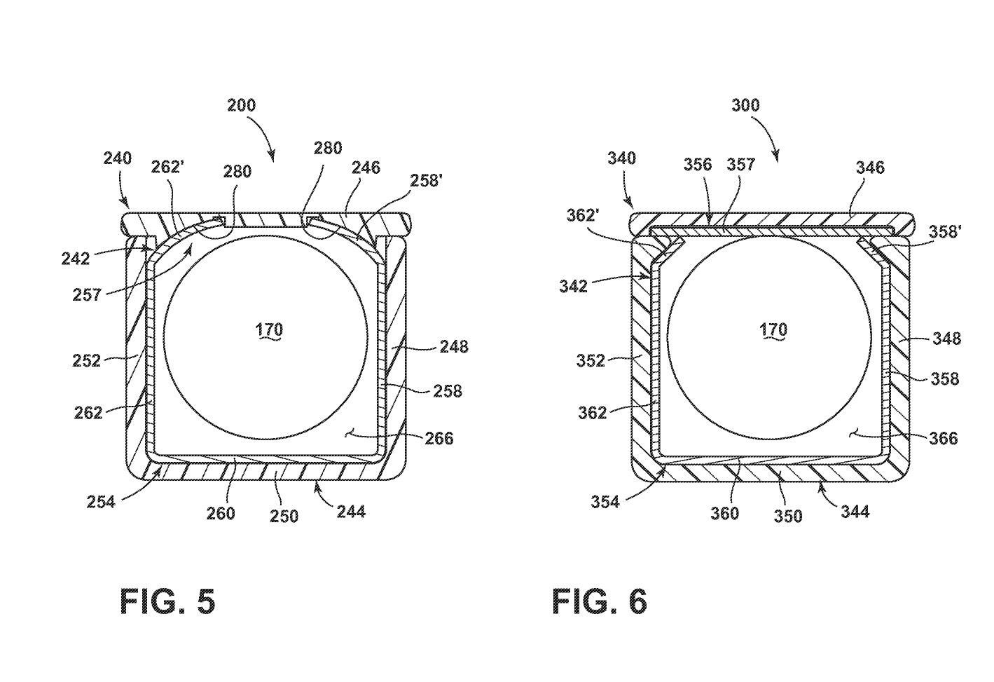

FIGS. 5-7 illustrate alternative embodiments 200, 300, and 400 of a balancer which are similar to the balancer 100 in that the non-metal annular housing and annular metal race have at least a first piece which has a generally U-shaped cross-section, but vary in the configuration of the enclosed non-metal annular housing and annular metal race. Similar to the balancer 100, all three of the balancers 200, 300, and 400 are configured such that at least the third race wall 262, 362, and 462 is disposed against the third housing wall, also referred to as the radial circumferential wall, 252, 352, and 452. Therefore, elements in the balancers 200, 300, and 400 similar to those in the balancer 100 are labeled with the prefix 200, 300, and 400 respectively. The balancers 200, 300, and 400 may be provided in the annular groove 118 of the drum cover 30 in a manner similar to that described above for the balancer 100 using any suitable mechanical and/or non-mechanical fastener.

Referring now to the balancer 200 of FIG. 5, the metal race 242 may include a single race piece 254 having first, second and third race walls 258, 260, and 262. The fourth wall 257 may be at least partially formed by an extension 258′ and 262′ of the first and third race walls 258 and 262, respectively, which have been bent inward to provide an at least partially enclosed raceway 266. The second housing piece 246 may be provided with an inner surface having complementary grooves 280 which receive the bent extensions 258′ and 262′ of the first and third race walls 258 and 262. The bent extensions 258′ and 262′ of the first and third race walls 258 and 262, respectively, may have a length such that the bent extensions 258′ and 262′ only partially form the fourth wall 257 with the remainder of the fourth wall 257 formed by the second housing piece 246. Alternatively, the bent extensions 258′ and 262′ may be configured such that a distal end of the bent extension 258′ contacts a distal end of the bent extension 262′ to form the fourth wall 257.

The extensions 258′ and 262′ may be bent before or after the race piece 254 is provided in the first housing piece 244 and may be bent before or after the mass 170 is placed within the annular raceway 266. The metal race piece 254 may be provided within the first housing piece 244 by inserting the race piece 254 into the space defined by the first, second and third housing walls 248, 250, and 252. Alternatively, the first housing piece 244 may be overmolded onto the metal race piece 254. If the mass 170 is placed within the annular raceway 266 after the extensions 258′ and 262′ are bent, the mass 170 may be provided into the annular raceway 266 through a gap between the distal ends of the extensions 258′ and 262′ or optionally through an appropriate sized port(s) provided elsewhere on the race piece 254.

Referring now to FIG. 6, the balancer 300 has a metal race 342 which includes the first race piece 354 and the second race piece 356, similar to the balancer 100 of FIG. 4, but also includes bent extensions 358′ and 362′, similar to the balancer 200 of FIG. 5. The first and third race walls 358 and 362 include extensions 358′ and 362′ which are bent inwards. The second race piece 356 may be provided on the bent extensions 358′ and 362′ to form the fourth wall 357 to enclose the annular raceway 366. In an exemplary embodiment, the second housing piece 346 is overmolded onto the second race piece 356. Similar to the balancer 200 of FIG. 5, the first race piece 354 may be inserted into the first housing piece 344 or the first housing piece 344 may be overmolded onto the first race piece 354, with the mass 170 being provided within the annular raceway 266 before or after the first race piece 354 is provided within the first housing piece 344.

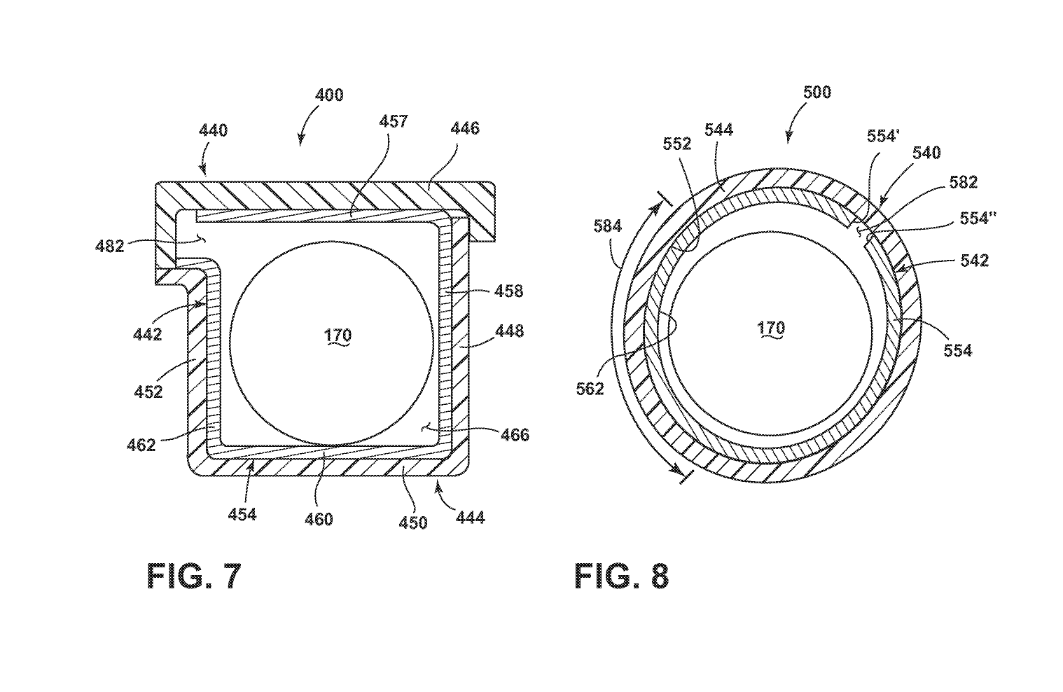

As illustrated in FIG. 7, the balancer 400 includes a metal race 442 made from a single race piece 454 which has been bent to form the first, second, third and fourth race walls 458, 460, 462 and 457. The second housing piece 446 is configured to be joined with the first housing piece 444 when the race piece 454 is disposed within the first housing piece 444. As illustrated in FIG. 7, the second housing piece 446 may be configured to accommodate a gap 482 formed between a distal end of the fourth race wall 457 and a distal end of the third race wall 462. The dimensions of the gap 482 may vary depending on the forming process used to bend the first, second, third and fourth race walls 458, 460, 462 and 457 to form the race piece 454. The gap 482 may be an artifact of the manufacturing process and in some cases the gap 482 may not be present at all. Similar to the balancers 200, 300, the race piece 454 may be formed and inserted into the annular raceway 466 of the first housing piece 444 or the first housing piece 444 may be overmolded onto the race piece 454. The fourth wall 457 may be bent before or after providing the race piece 354 within the first housing piece 444 and/or before or after providing the mass 170 within the race piece 454.

FIG. 8 illustrates another embodiment of the balancer 500, which is similar to the balancer 100 except that the non-metal annular housing 540 and annular metal race 542 are each formed from a single piece having a circular cross-section. Therefore, elements in the balancer 500 similar to those in the balancer 100 are labeled with the prefix 500. The metal race 542 may be formed by rolling or bending the race piece 554 into the desired shape. The race piece 554 may be rolled such that a gap 582 is provided between opposing distal ends 554′ and 554″ or until the distal ends 554′, 554″ are in contact. The race piece 554 may be formed and then the housing piece 544 may be overmolded onto the race piece 554, either before or after the race piece 554 is bent into the annular shape. Alternatively, the race piece 554 may be formed and inserted into a pre-formed housing piece 544 and then the balancer 500 may be bent into the annular shape. As described above with respect to the balancers 100, 200, 300, and 400, the mass 170 may be provided within the race piece 554 at any point during the manufacturing or assembly of the balancer 500 either by forming the race piece 554 around the mass 170 and/or providing suitable ports for adding the mass 170 after the race piece 554, and optionally the housing piece 544, are formed.

Because the housing piece 544 and the race piece 554 have a circular cross-section, the housing and race pieces 544, 554 do not have multiple, distinct walls. Thus, the circumferential radial wall of the housing and race pieces 544, 554 is defined as an outer portion of the housing and race pieces 544, 554 which provides a circumferential radial surface with respect to the longitudinal axis 21 of the drum 16. The race piece 554 is provided within the housing piece 544 such that at least the portion of the race piece 554 forming the circumferential radial surface is disposed against the portion of the housing piece 544 forming the circumferential radial surface. Line 584 delineates portions of the housing and race pieces 544, 554 which provide the circumferential surface 552 and 562, respectively, according to an exemplary embodiment.

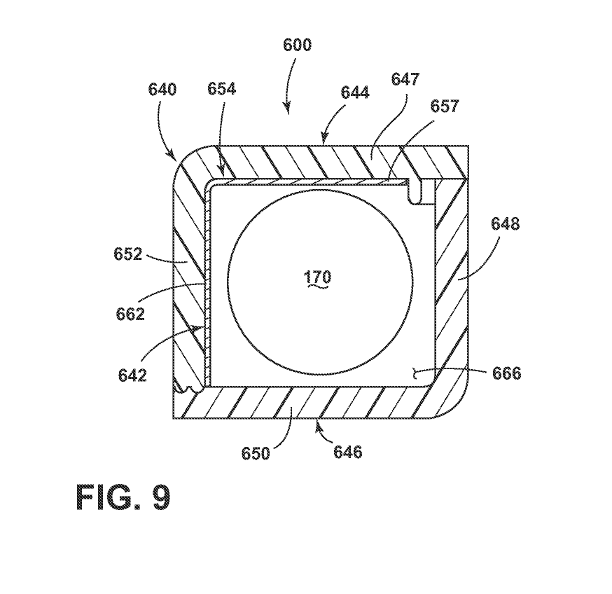

FIGS. 9-11 illustrate another embodiment of the balancer 600 which is similar to the balancer 100 except that the non-metal annular housing 640 and annular metal race 642 are each formed from two pieces having an L-shaped cross-section rather than the U-shaped cross-section of the balancer 100. Therefore, elements of the balancer 600 similar to those of the balancer 100 are labeled with the prefix 600.

The first housing piece 644 includes an L-shaped cross-section piece formed by the first housing leg 647 and the second housing leg 652 that is joined with the second housing piece 646. The second housing piece 646 includes an L-shaped cross-section piece formed by the third housing leg 648 and the fourth housing leg 650 with the third housing leg 648 joined with the first housing leg 647 and the fourth housing wall leg 650 joined with the second housing leg 652 to form an enclosed annular raceway 666. The first and second housing pieces 644 and 646 may be joined by any suitable mechanical and/or non-mechanical fasteners, non-limiting examples of which include a tongue and groove connection, a weld, a snap-fit connection, an adhesive, screws, rivets, and bosses.

As illustrated in FIG. 9, the annular metal race 642 may include a single race piece 654 having a first race leg 657 and a second race leg 662. The race piece 654 has an L-shaped cross-section corresponding to the cross-section of the first housing piece 644 and is provided on the first housing piece 644 such that the first and second race legs 657, 662 form two of the walls of the annular raceway 666. The balancer 600 may be provided on the drum 16 such that the second housing leg 652 and the second race leg 662 form the radial circumferential housing and race leg, respectively, with respect to the longitudinal axis 21 of the drum 16.

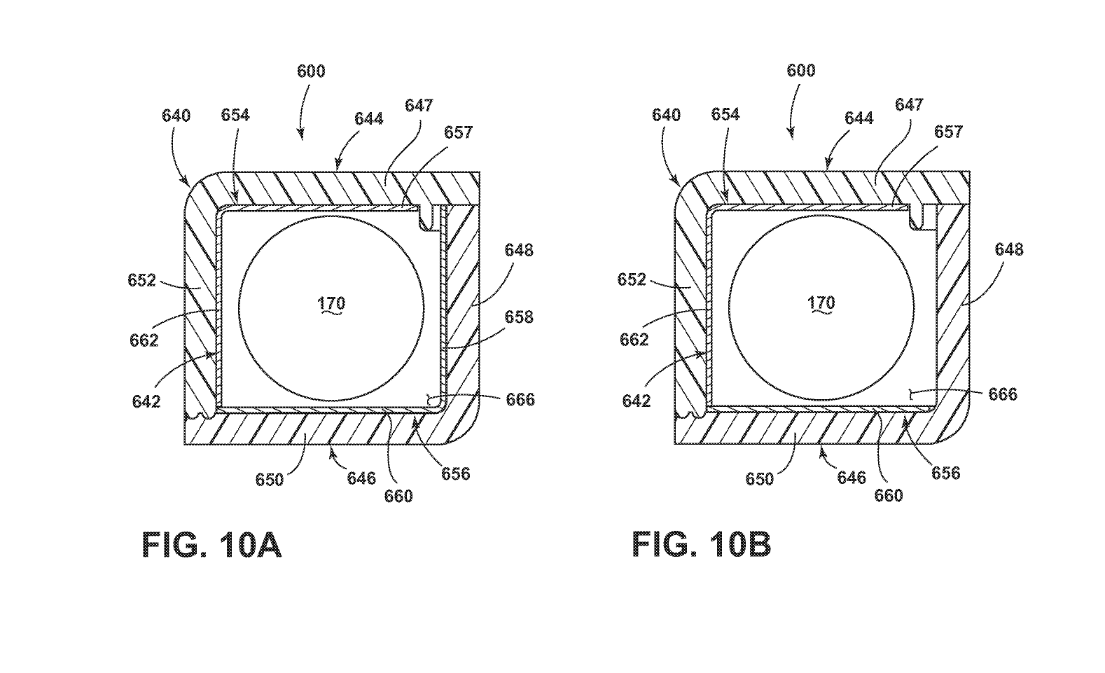

Referring now to FIG. 10A, the annular metal race 642 may optionally include a second race piece 656 having an optional third race leg 658 and/or fourth race leg 660. In the embodiment of FIG. 10A, the second race piece 656 has an L-shaped cross-section corresponding to the cross-section of the second housing piece 646 and is provided on the second housing piece 646 such that the third and fourth race legs 658, 660 form the other two of the walls of the annular raceway 666. It is also within the scope of the invention for the second race piece to only include the fourth race leg 660.

The annular metal race 642 is provided within the annular housing 640 such that at least the second, radial circumferential race leg 662 is disposed against the second, radial circumferential housing leg 652. In another example, a portion of the first and second housing legs 647 and 652 define a first part of the radial circumferential wall and a portion of the fourth leg 650 defines a second part of the radial circumferential wall, the first and second parts of the radial circumferential wall together defining a C-shaped cross section. The race legs 657, 660, and 662 of the first and second race pieces 654, 656 may be configured to have a C-shaped cross-section corresponding to the C-shaped cross section of the first and second parts of the radial circumferential wall formed in part by the first, second and fourth legs 647, 652, and 650 of the annular housing 640 with the C-shaped cross-section portion of the metal race 642 disposed against the C-shaped cross-section of the annular housing 640, as shown in FIG. 10B.

Either or both of the first and second housing pieces 644 and 646 may be overmolded onto the corresponding race pieces 654 and 656, respectively. In one example, the first housing piece 644 may be overmolded onto the first race piece 654 while the second race piece 656 is inserted into the second housing piece 646 prior to joining the first and second housing pieces 644, 646. Similar to the balancers 100, 200, 300, 400, and 500 described above, the mass 170 may be provided within the raceway 666 before or after first and second housing pieces are joined.

It will be understood that more than one dynamic balancer 100, 200, 300, 400, 500, and 600 may be disposed in a laundry treating device. For example, in a horizontal axis washing machine, there may be a dynamic balancer 100, 200, 300, 400, 500, and 600 at both the front and rear sides 17, 19 of the rotatable drum 16. It will be further understood that the dynamic balancer 100, 200, 300, 400, 500, and 600 may be coupled with the drum 16 anywhere on the covers 30, 34 or on the cylindrical wall 114. As well, the covers 30, 34 may or may not have an annular groove 118.

The dynamic balancers 100, 200, 300, 400, 500 and 600 described herein combine a non-metal housing with a metal race to dampen sound generated by movement of the moveable mass 170 within the metal race. As discussed above, during a cycle of operation in which the drum 16 is rotated, the components of the balancers 100, 200, 300, 400, 500 and 600 may experience centrifugal forces acting upon them by the moveable mass 170 therein, especially when the drum 16 is rotated at high speeds. When the moveable mass 170 is in the form of a metal ball, contact between the balls and plastic forming the annular raceway within which the mass 170 moves may deform or damage the plastic and may inhibit free rolling motion of the balls over time. While forming the components of the balancer 100, 200, 300, 400, 500 and 600 from metal, which is generally stiffer than plastic, may decrease the likelihood of deformation or damage of the raceway over time, movement of metal balls against a metal surface may generate undesirable noise.

The dynamic balancers 100, 200, 300, 400, 500 and 600 described herein provided a metal race piece along at least the radial circumferential wall of the non-metal housing to increase the stiffness of the portion of the raceway which experiences the majority of the centrifugal forces present during rotation of the drum 16. During rotation of the drum 16, the mass 170 experiences centrifugal forces which propels the mass 170 radially outward from the axis of rotation of the drum and therefore the portion of the balancer defining the radial circumferential limit of motion for the mass 170 experiences pressure from the centrifugal force of the mass 170. The portion of the balancer defining the radial circumferential limit of motion for the mass 170 may include a single wall or leg of the annular housing or a combination of multiple walls or legs. Metal is stiffer than non-metal materials, such as plastic, and thus a metal race piece may be provided along at least the portion of the non-metal housing forming the radial circumferential wall. As the speed of rotation of the drum 16 increases and decreases, the mass 170 may contact other portions of the raceway and thus a metal race may be provided along all of the walls or surfaces of the non-metal annular housing forming the raceway.

The balancer 100, 200, 300, 400, 500 and 600 may provide the metal race within the non-metal annular housing such that at least the portion forming the radial circumferential wall is disposed against the non-metal annular housing to dampen undesirable noise generated by the motion of the metal balls against the metal walls race. In an exemplary embodiment, the non-metal annular housing may be overmolded onto one or more portions of the metal race to form an integral part that combines the stiffness of metal with the sound dampening properties of plastic. Overmolding the annular housing onto the metal race may also provide cost and time savings in manufacturing and assembly.

To the extent not already described, the different features and structures of the various embodiments may be used in combination with each other as desired. That one feature may not be illustrated in all of the embodiments is not meant to be construed that it cannot be, but is done for brevity of description. Thus, the various features of the different embodiments may be mixed and matched as desired to form new embodiments, whether or not the new embodiments are expressly disclosed.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

What is claimed is:

1. A dynamic balancer device for mounting to and balancing a rotatable drum in a laundry treating appliance comprising:
an enclosed non-metal annular housing having a radial circumferential wall;
an annular metal race within the non-metal annular housing disposed against the radial circumferential wall; and
a mass disposed in the annular race and movable therein.

2. The dynamic balancer device of claim 1 wherein the enclosed non-metal annular housing includes a first piece having an L-shaped cross-section defined by a first leg and a second leg; and
a second piece having an L-shaped cross-section defined by a third leg and a fourth leg;
wherein the first leg is joined to the third leg, and the second leg is joined to the fourth leg, and the second leg is the radial circumferential wall.

3. The dynamic balancer device of claim 2 wherein the annular metal race has an L-shaped cross-section corresponding to the first piece L-shaped cross-section and disposed against the first and second legs.

4. The dynamic balancer device of claim 3, further comprising a second annular metal race having an L-shaped cross-section corresponding to the second piece L-shaped cross-section and disposed against the third and fourth legs.

5. The dynamic balancer device of claim 2 wherein a portion of the first and second legs defines a first part of the radial circumferential wall and a portion of the fourth leg defines a second part of the radial circumferential wall, the first and second parts together defining a C-shaped cross section, and the annular metal race has a C-shaped cross-section corresponding to the C-shaped cross section of the first and second parts.

6. The dynamic balancer device of claim 2 wherein the first and second pieces are joined together by at least one of a weld, a snap-fit, a mechanical fastener, an adhesive or any combination thereof.

7. The dynamic balancer device of claim 1 wherein the non-metal annular housing is overmolded to the annular metal race.

8. The dynamic balancer device of claim 1 wherein the mass includes at least one of balls, viscous fluid, or water.

9. The dynamic balancer device of claim 1 wherein the annular metal race is made from steel or aluminum.

10. The dynamic balancer device of claim 1 wherein the enclosed non-metal annular housing includes a first piece having a U-shaped cross-section defined by first, second, and third walls; and
a second cover piece;
wherein the second cover piece is joined to the first and third walls and the third wall is the radial circumferential wall.

11. The dynamic balancer device of claim 10 wherein the annular metal race has a U-shaped cross-section corresponding to the first piece U-shaped cross section and disposed against the first, second, and third walls.

12. The dynamic balancer device of claim 11, further comprising a second metal cover piece, wherein the second metal cover piece is joined to the second cover piece and encloses the annular metal race when the second cover piece is joined to the first and third walls.

13. The dynamic balancer device of claim 12 wherein the annular metal race U-shaped cross-section is partly defined by spaced metal walls and each of the spaced metal walls has an extension that is deformed inwardly by the second cover piece when the second cover piece is joined to the first and third walls.

14. The dynamic balancer device of claim 1 wherein the enclosed non-metal annular housing has a circular cross-section, an outer portion of which defines the radial circumferential wall.

15. The dynamic balancer device of claim 14 wherein the annular metal race has a circular cross section.

16. A method of making a dynamic balancer for a rotatable drum of a laundry treating appliance, the method comprising:
forming a first piece of a non-metal annular housing;
forming a second piece of a non-metal annular housing, wherein the first and second pieces are configured to enclose the non-metal annular housing when joined together, and at least one of the first and second pieces or both of the first and second pieces form a radial circumferential wall in the enclosed non-metal annular housing;
forming an annular metal race;
disposing the annular metal race against the radial circumferential wall; and
providing a mass in the annular metal race for movement therein.

17. The method of claim 16 wherein the first and second pieces are formed by molding a polymeric material.

18. The method of claim 17 further comprising overmolding the annular metal race with at least one of the first or second pieces.

19. The method of claim 16 wherein the annular metal race is formed of steel or aluminum.

20. The method of claim 16 wherein the mass includes at least one of balls, viscous fluid, or water.
